(19) United States
(12) Patent Application Publication
(10) Pub. No.: US 2026/0278109 A1
(43) Pub. Date: Sep. 17, 2026

(54) LLM-DRIVEN ITERATIVE VULNERABILITY VALIDATION FOR STATIC CODE ANALYSIS

(71) Applicant: Lenovo (United States) Inc., Morrisville, NC (US)

(72) Inventors: Scott Li, Morrisville, NC (US); Igor Stolbikov, Morrisville, NC (US); Robert Paul Michel, Morrisville, NC (US); Ramakrishnan Kandasamy, Morrisville, NC (US)

(21) Appl. No.: 19/077,431

(22) Filed: Mar. 12, 2025

(51) Int. Cl. G06F 21/57; G06F 21/56

(52) U.S. Cl. CPC G06F 21/577; G06F 21/563; G06F 2221/033

(57) ABSTRACT

In one aspect, large language models (LLMs) are used to evaluate static application security testing (SAST) results from a SAST tool that is run on software under test. A software vulnerability report is then generated based on one or more outputs from the LLM(s), with the outputs indicating levels of confidence in the respective SAST results being actual positives. In this way, false positives from the SAST results can be eliminated or deprioritized, providing technological improvements in pre-deployment software testing and validation.

### FIELD

The disclosure below relates to technically inventive, non-routine solutions that are necessarily rooted in computer technology and that produce concrete technical improvements. In particular, the disclosure below relates to large language model (LLM)-driven iterative vulnerability validation for static code analysis.

### BACKGROUND

As recognized herein, static application security testing (SAST) tools provide a relatively high volume of false positives when identifying vulnerabilities in software that is being validated. This creates the need for cumbersome individual validation of each result to decipher whether the result indicates an actual vulnerability or a false positive. There are currently no adequate solutions to the foregoing computer-related, technological problem.

### SUMMARY

Accordingly, in one aspect a device includes a processor system and storage accessible to the processor system. The storage includes instructions executable by the processor system to execute a static application security testing (SAST) tool to generate a first output related to one or more vulnerabilities in a software that is to be tested. The instructions are also executable to provide, as a first input to a first large language model (LLM), the first output related to the one or more vulnerabilities in the software. The instructions are then executable to receive, from the first LLM in response to the first input, one or more test codes for respective tests to run on the software. The instructions are then executable to execute the one or more test codes on the software to generate data indicating one or more respective test results. Then the instructions are then executable to provide, as a second input to a second LLM, the data indicating the one or more respective test results. Thereafter, the instructions are executable to receive, from the second LLM in response to the second input, a second output related to the one or more vulnerabilities. The instructions are further executable to generate a vulnerability report based on the second output from the second LLM.

In various non-limiting examples, the one or more test codes may include one or more unit tests, one or more integration tests, and/or one or more parameterized tests.

Also in various non-limiting examples, the second output may indicate a level of confidence in one or more SAST results from the execution of the SAST tool, where the one or more SAST results may be related to the one or more vulnerabilities. Additionally or alternatively, the second output may indicate whether a respective vulnerability of the one or more vulnerabilities is a false positive.

In certain examples, the second LLM may be the same as the first LLM, while in other examples the second LLM may be different from the first LLM. Also in various examples, the software may establish an executable environment.

If desired, in some instances the instructions may also be executable to provide, as the first input to a first large language model (LLM), both the software itself and the first output related to the one or more vulnerabilities in the software.

Also in some particular embodiments, the vulnerability report may be generated to rank the one or more vulnerabilities according to the second output from the second LLM. For instance, the one or more vulnerabilities may be ranked in the vulnerability report from more critical to less critical.

In another aspect, a method includes executing a static application security testing (SAST) tool to generate a first output related to one or more vulnerabilities in a software that is to be tested. The method also includes providing, as a first input to a first large language model (LLM), the first output related to the one or more vulnerabilities in the software. The method further includes receiving, from the first LLM in response to the first input, one or more test codes for respective tests to run on the software. The method also includes executing the one or more test codes on the software to generate data indicating one or more respective test results. From there the method includes providing, as a second input to a second LLM, the data indicating the one or more respective test results. The method also includes receiving, from the second LLM in response to the second input, a second output related to the one or more vulnerabilities. The method then includes providing a vulnerability report based on the second output from the second LLM.

In various example implementations, the one or more test codes may include one or more unit tests, one or more integration tests, and/or one or more parameterized tests.

Also in various example implementations, the second LLM may be different from the first LLM. What's more, in some instances the software may establish an executable environment.

In still another aspect, at least one computer readable storage medium (CRSM) that is not a transitory signal includes instructions executable by a processor system. The instructions are executable to use one or more large language models (LLMs) to evaluate static application security testing (SAST) results from a SAST tool. The instructions are also executable to generate a software vulnerability report based on one or more outputs from the one or more LLMs that are related to the SAST results.

In some specific examples, the instructions may be executable to use a first LLM of the one or more LLMs to generate one or more test codes for respective tests to run on software to which the SAST results are related. Here the instructions may also be executable to use a second LLM of the one or more LLMs both to evaluate test results from execution of the test codes on the software, and to assign a respective confidence score in each SAST result for indication in the software vulnerability report based on the evaluation of the test results. The one or more test codes may include one or more unit tests, one or more integration tests, and/or one or more parameterized tests.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 is a schematic diagram showing an example code analysis and testing flow consistent with present principles;

FIG. 4 demonstrates example software architecture interplay for an LLM-driven iterative vulnerability validation of a static code analysis consistent with present principles;

FIG. 5 shows a schematic diagram of an example LLM-based iterative vulnerability validation system consistent with present principles;

FIG. 6 shows a schematic diagram of an AI-driven iterative vulnerability validation system web application (app) consistent with present principles;

FIG. 7 shows an example vulnerability report that may be generated and then presented on an electronic display consistent with present principles; and

FIG. 8 illustrates example overall logic in flow chart format that may be executed by one or more devices consistent with present principles.

### DETAILED DESCRIPTION

Note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS or iOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single-or multi-chip processor that can execute logic by means of various lines such as address lines, data lines, and control lines and registers and shift registers. Moreover, any logical blocks, modules, and circuits described herein can be implemented or performed with a system processor such as a central processing unit (CPU), a graphics processing unit (GPU), a neural processing unit (NPU), a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in the art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/ or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C #or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “a” or “an” in reference to an entity refers to one or more of that entity. As such, the terms “a” or “an”, “one or more”, and “at least one” can be used interchangeably herein. “A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

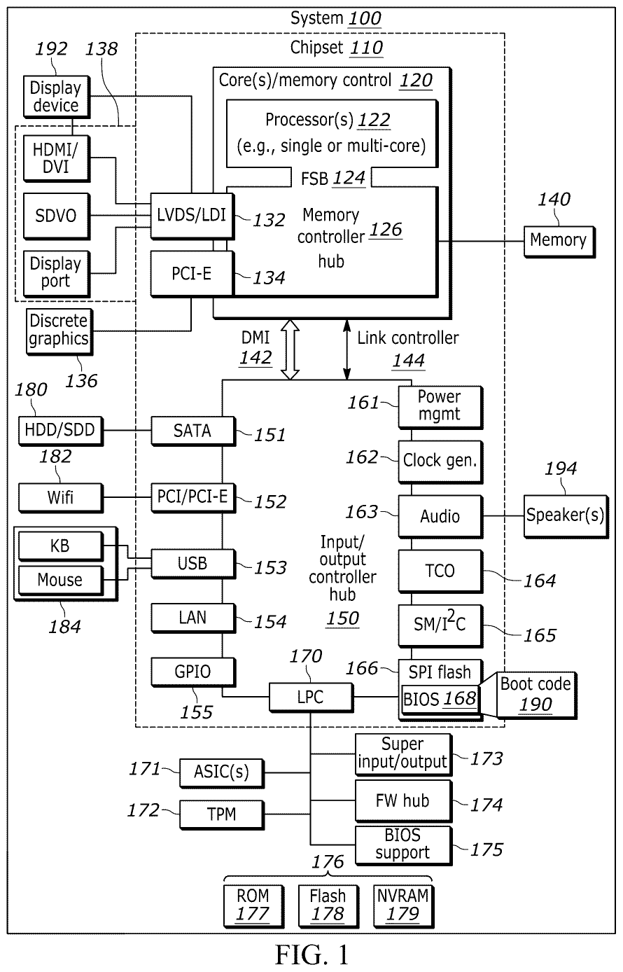

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre®, or notebook computer system, such as ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor system 122 (e.g., one or more single core or multi-core processors, etc.) and a memory controller hub 126 that exchange information via a front side bus (FSB) 124. A processor system such as the system 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. For example, the memory controller hub 126 may include a 16-lane (x16) PCI-E port for an external PCI-E-based graphics card (including, e.g., one or more GPUs). An example system may thus include PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor system 122, an accelerometer that senses acceleration and/or movement of the system 100 and provides related input to the processor system 122, and/or a magnetometer that senses and/or measures directional movement of the system 100 and provides related input to the processor system 122.

Still further, the system 100 may include an audio receiver/microphone that provides input from the microphone to the processor system 122 based on audio that is detected, such as via a user providing audible input to the microphone. The system 100 may also include a camera that gathers one or more images and provides the images and related input (e.g., metadata like an image timestamp) to the processor system 122. The camera may be a thermal imaging camera, an infrared (IR) camera, a digital camera such as a webcam, a three-dimensional (3D) camera, and/or a camera otherwise integrated into the system 100 and controllable by the processor system 122 to gather still images and/or video.

Also, the system 100 may include a global positioning system (GPS) transceiver that is configured to communicate with satellites to receive/identify geographic position information and provide the geographic position information to the processor system 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

Present principles may employ various machine learning (ML) models, including deep learning models. ML models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTs) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

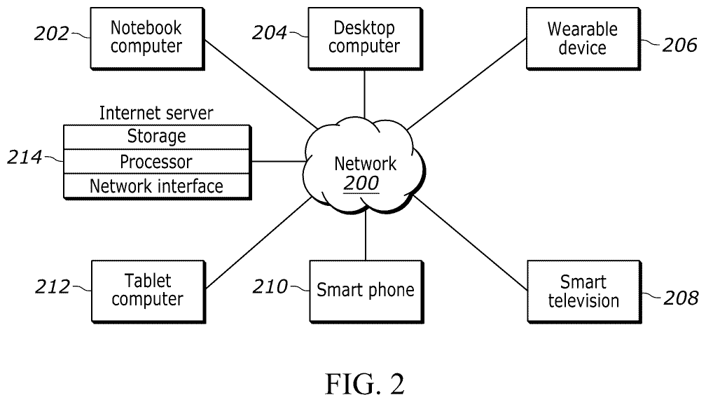

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 may be configured to communicate with each other over the network 200 to undertake present principles, including the client device and server communications discussed below.

With the foregoing in mind, it is to be understood that Static Application Security Testing (SAST) tools can be used in conjunction with Large Language Models (LLMs) to reduce false SAST positives for identified software vulnerabilities (e.g., vulnerabilities that might cause the software to crash or be hacked). The LLM can therefore generate targeted test cases (code) to validate findings from SAST-based analyses and other types of code testing/analyses, helping to identify false positives and continuously improving the accuracy of vulnerability detection across various types of security weaknesses.

Thus, in one aspect a system may be implemented that integrates static code analysis, LLMs, and innovative testing and test code generation methodologies to enhance and improve the accuracy of software vulnerability detection and validation. This system can help reduce false positives and enhance the overall efficiency of security assessments through an iterative, self-improving process.

To do so, in one example, the system may perform a dual code analysis of the target codebase. One or more SAST tools can scan the software code (e.g., executable application/environment) for known vulnerability patterns, while an LLM-based analyzer may examine the code semantically. This combination may help with the detection of both established and potentially novel security issues. Following these initial scans, the system can categorize identified issues according to one or more vulnerability classification systems such as the Common Weakness Enumeration (CWE).

For each identified issue, the system may then employ an LLM (same or different) to generate a suite of test cases. These tests may include unit tests for individual functions or methods, integration tests to evaluate environmental interactions, and parameterized tests to cover multiple attack vectors efficiently. The test generation process may be guided by the specific characteristics of each potential vulnerability and what the software code is meant to actually do, making the LLM particularly suited to the task.

Test execution may subsequently occur in a controlled environment that simulates the target system's configuration. This environment may incorporate mocking of external dependencies and system calls to ensure reproducibility and to prevent unintended side effects. The execution phase may collect data on test outcomes, code coverage, and execution paths. An LLM-based analysis may then evaluate the test results. This evaluation may consider multiple factors, including test pass/fail status, code coverage metrics, and the specific execution paths triggered during testing. Based on this analysis, the system may assign a confidence score to each potential vulnerability, indicating the likelihood of that vulnerability being a true positive (as opposed to a false positive).

For findings with confidence scores below a predetermined threshold, the system may initiate an iterative refinement process. This may involve refining the initial analysis, generating additional test cases with increased specificity, and re-executing the tests and/or executing additional tests. In non-limiting examples, the iteration may continue until either the confidence score reaches the threshold or a maximum iteration limit is reached.

Then at end of the iterative loop/process, the system may generate a technical report. The report may include details on confirmed vulnerabilities, potential false positives, confidence scores, test cases and their results, and suggested remediation steps. If desired, the level of detail can be changed for the target audience, such as security code reviewers or software developers

Thus, present principles encompass an innovative combination of LLM-based analysis and iterative testing to enable a computing system to identify novel, previously unknown and known attack vectors. Present principles also provide for adaptive test case generation in which LLMs are used to generate tailored test cases for each identified vulnerability, including unit, integration, and parameterized tests based on the code base for the software, the function and the type of vulnerability. Present principles also provide for iteratively refining the system's analysis and test generation based on confidence scores. Present principles may also provide systematic ability to disambiguate vulnerabilities based on similar vulnerability knowledge and test outcomes, enhancing detection accuracy.

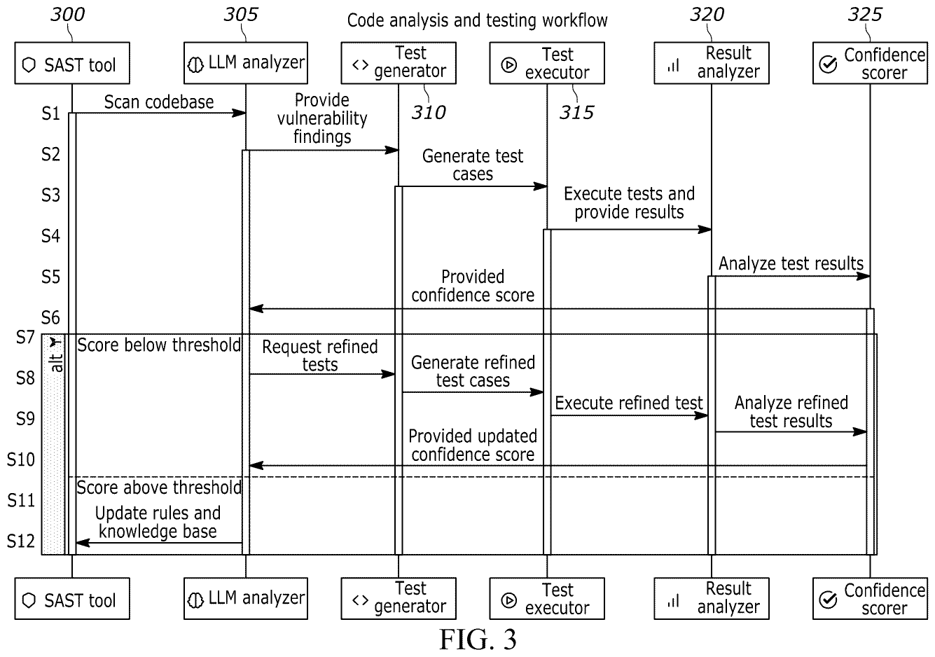

With this understanding, reference is now made to the schematic diagram of FIG. 3. This figure shows an overall code analysis and testing flow consistent with present principles. As shown, different software entities/modules that act in concert to implement present principles may include a SAST tool 300, an LLM analyzer 305, a test generator (LLM) 310, a test executor 315, a result analyzer 320, and a confidence scorer 325.

Describing the process flow in greater detail, at step S1 the SAST tool 300 may scan the code database of the executable software application (“app”) under test and provide the test results to the LLM analyzer 305. Then at step S2 the LLM analyzer 305 may analyze the SAST results to provide vulnerability findings to the test generator 310 as output. Thereafter, at step S3 the test generator 310, which may be established by the same LLM or a different LLM as embodied in the LLM analyzer 305, may generate one or more test cases (or test codes more generally).

FIG. 3 also shows that the process flow may then proceed to step S4 where the text executor 315 may execute the generative test codes generated by the generator 310 and then provide the corresponding test results to the result analyzer 320. From there, at step S5 the result analyzer 320 may analyze the test results and provide associated analysis outcome data to the confidence scorer 325. Note that the result analyzer 320 may be the same as one of the other LLMs embodied in the analyzer 305 and/or test generator 310, and/or may be established by a third (different) LLM. If different LLMs are used, each one may be trained specifically for the task it handles consistent with this description, which may help provide an overall system tuned to the tasks at hand. However, in other implementations, it may instead be advantageous to use the same (single) LLM to allow this LLM to use the context it builds through the process to its advantage in rendering later outputs.

In any case, in terms of the confidence scorer 325 itself, it may translate the test result analysis from the analyzer 320 to, at step S6, report a confidence score to the LLM analyzer 305. Note that the scorer 325 may in whole or in part be established by the same LLM as the analyzer 320 to output a confidence score at an output layer (or to otherwise infer a confidence score via that LLM). Additionally or alternatively, the scorer 325 may be established by its own ML model configured to infer a level of confidence in each SAST-identified vulnerability according to the analysis of test results output by the analyzer 320.

After step S6, the aforementioned iterative refinement process may ensue. Here, SAST-identified vulnerabilities that have been identified as having a respective confidence score below a threshold confidence amount may be further addressed. Thus, true positive vulnerabilities may be assumed when their score is above the threshold, while potential false positive vulnerabilities may undergo further analysis based on their scores being below the threshold.

Accordingly, at step S7 the LLM analyzer 305 may, in response to receiving the confidence scores at step S6, request refined tests (test codes) from the test generator 310, which may then generate refined test cases/codes at step S8. The test generator 310 may then provide the generative test codes to the test executor 315 for the executor 315 to then execute the test codes on the software code under test at step S9, with it being reiterated that each test code may attempt to validate the respective vulnerability for which it was created (at this point, the vulnerabilities under the confidence threshold which might be false positives).

The results of the refined tests may then be provided to the analyzer 320 for the analyzer 320 to analyze the refined test results at step S10. The analysis may then be provided to the confidence scorer 325 to, at step S11, provide an updated confidence score for each vulnerability in question based on the analysis.

Still in reference to FIG. 3, note that for each score about the threshold, either on initial test or through the iterative process, at step S12 the system may also update the rules and knowledge base of the system, including one or more of the LLMs and other ML models described herein. Thus, in certain instances, at step S12 the LLM(s) and/or other ML models may be further trained using the data from the current process flow instance as training data. Supervised learning, unsupervised learning, reinforcement learning, and other ML learning techniques may therefore be used.

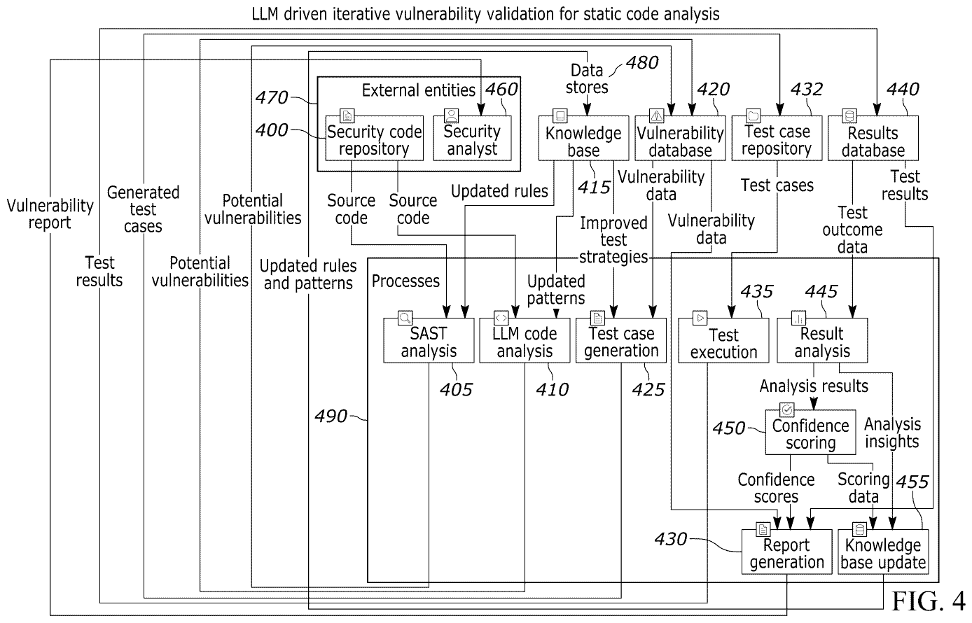

Turning now to FIG. 4, another example schematic diagram is shown consistent with present principles. Specifically, FIG. 4 shows a schematic of software architecture interplay for an LLM-driven iterative vulnerability validation of a static code analysis that may be implemented in conjunction with other aspects described herein. As shown, the architecture may include a source code repository 400 that stores the source code of one or more executable apps to be tested. A SAST analysis tool 405 and an LLM code analyzer 410 may therefore both access the same first source code for a first app to test via the repository 400. Note that updated rules from a knowledge base 415 may also be provided to the SAST tool 405 to help with its SAST tests on the first source code. Further note that updated patterns from the knowledge base 415 may be provided to the LLM code analyzer 410 for its own analysis of the first source code.

FIG. 4 also shows that respective results from the tool 405 and analyzer 410 that indicate vulnerabilities in the first source code as identified by each one may then be provided to a vulnerabilities database 420. The database 420 may then provide corresponding vulnerability data to both a test case generation module 425 and a report generation module 430.

The module 425 may then use the vulnerability data along with any improved (iterative) test strategies from the knowledge base 425 to output generated test cases (test codes more generally) to the test case repository 432. The repository may then provide the associated test cases to the test executor 435 for the executor 435 to generate test results from the test cases. The executor may then report to the results database 440.

The database 440 may then be used to do two things. First, the system may provide corresponding test outcome data as stored in the database 440 to a result analyzer 445. The analyzer 445 may then output corresponding analysis results for the confidence scoring module 450 to then provide corresponding confidence scores to the report generation module 430 and scoring data to the knowledge base updater 455. Second, the system may provide test results from the associated tests directly to the report generation module 430.

FIG. 4 also shows that the report generation module 430 may then be used to generate a vulnerability report which is subsequently provided to the security analyst 460, which might form part of the same external entity section 470 of the system as the repository 400. Note that this report may be generated based on one or more of the vulnerability data from the database 420, confidence scores from the module 450, and/or test results from the results data base 440.

Additionally, the knowledge base updater 455 may be used to generate updated rules and patterns, which are then provided as data stores to the knowledge base 415. Note that the updated rules and patterns may be generated using both the scoring data from the module 450 and analysis insights from the analyzer 445.

Accordingly, it may be appreciated that the software architecture of FIG. 4 may include different classes of entities working in conjunction with each other to provide a vulnerability report that omits or lower-ranks at least some false positives. The entity classes may include the external entities 470 (including repository 400 and analyst 460), data stores 480 (including knowledge base 415, database 420, repository 432, and database 440), and processes 490 (including tool 405, LLM analyzer 410, LLM test generator 425, test executor 435, analyzer 445, module 450, module 430, and updater 455).

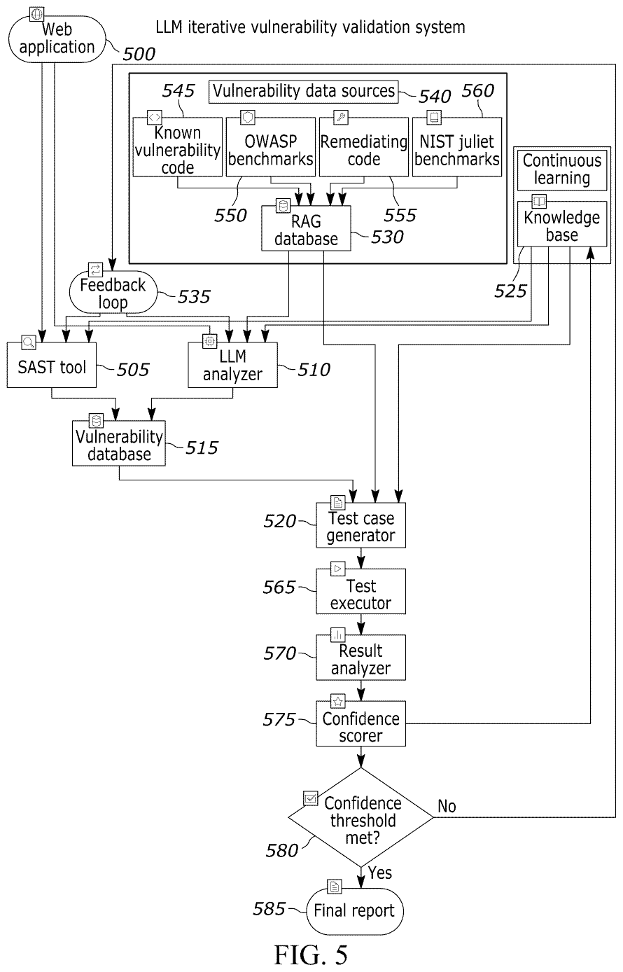

FIG. 5 shows another schematic diagram that illustrates present principles. Specifically, FIG. 5 shows a schematic of an LLM iterative vulnerability validation system that may be implemented in conjunction with other aspects described herein. As shown, a web app 500 may be used to access a SAST tool 505 as well as an LLM analyzer 510, each of which may then be employed through the web app 500 to independently analyze source code of an executable app consistent with present principles. Corresponding outputs of potential vulnerabilities in the source code may then be provided by the tool 505 and analyzer 510 to a vulnerability database 515, which may store the identified potential vulnerabilities and then report them to a test case generator 520 that will generate one or more test codes (e.g., unit tests, integration tests, and/or parameterized tests) to target and test the identified vulnerabilities. And note that the outputs of potential vulnerabilities may be identified by the tool 505 and analyzer 510 using vulnerability and source code data from the knowledge base 525, data from the retrieval-augmented generation (RAG) database 530, and, in later cycles of the iterative process as will be described in a moment, data from feedback loop 535.

Describing the RAG database 530 in greater detail, it may be established by various vulnerability data sources 540 that establish ground truth for the system's LLMs. The data sources 540 may therefore include known vulnerability code 545 (e.g., confirmed vulnerabilities is prior software versions of the same or different software type), Open Worldwide Application Security Project (OWASP) benchmarks 550, remediating code 555, and National Institute of Standards and Technology (NIST) Juliet benchmarks 560. The RAG database 530 may thus be accessed by one or more of the LLMs disclosed herein for the LLM to incorporate ground truth data into the inferences that it outputs, as sourced from the RAG database 530. Thus, the RAG database 530 may act as an authoritative database apart from each LLM's individual training, enhancing the accuracy of that LLM's outputs.

Back to the test case generator 520. Consistent with other figures above, once the test codes are generated by the generator 520, they may then be provided to the test executor 565 to execute the corresponding tests. Test results may then be provided to the result analyzer 570 (e.g., an LLM) for analysis, the results of which are then provided to the confidence scorer 757 to output a corresponding confidence score in the respective vulnerability itself that was identified by the SAST tool 505 and/or analyzer 510. The output of the confidence score may then be provided to the knowledge base 525 for continuous learning through iterations of the process and also in other validation instances.

The confidence score for each vulnerability may also be used at decision diamond 580 to determine whether the aforementioned confidence threshold is met. A negative determination may cause the system to revert to the feedback loop 535 and begin the process again as a subsequent iteration for determining whether the respective vulnerability whose confidence is currently below the threshold is indeed an actual/true positive (or just a false positive). This may include employing LLMs again to generate different, refined test codes to further test the relevant vulnerability.

However, an affirmative determination at diamond 580 may instead cause the system to proceed to step 585. At step 585 the system may generate a final report indicating the identified vulnerabilities in the source code that might warrant further investigation and testing by a system admin. Note that according to this example, identified vulnerabilities with a respective confidence score below the threshold amount may not be included in the report as they have the potential to be false positives, though in other examples those potential false positives may still be presented in the report as less critical vulnerabilities that are ranked lower than other vulnerabilities in relation to potentially requiring additional investigation.

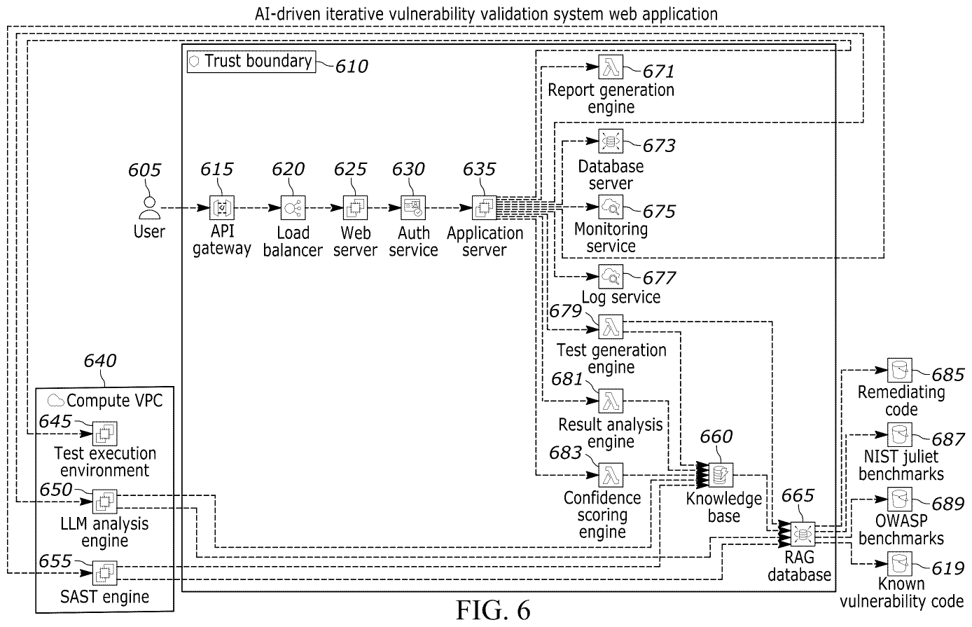

Continuing the detailed description in reference to FIG. 6, this figure shows a schematic diagram of an AI-driven iterative vulnerability validation system web application (app) that may be implemented in conjunction with other aspects described herein. Accordingly, a user 605 may open/execute the app at a client device, causing one or more graphical user interfaces (GUIs) to be presented through which source code to test may be specified and other corresponding user commands provided. The app may then employ items in a trust boundary 610 to undertake present principles.

Specifically, the user's input to the GUI(s) may be provided to an application programming interface (API) gateway 615 which communicates the code and user commands to a load balancer 620, which in turn relays corresponding data to a web server 625 that interfaces with an authentication service 630 to authenticate the source code and commands prior to providing them to an application server 635.

The application server 635 may then provide the source code and test commands to a compute virtual private cloud (VPC) 640. The VPC 640 may then test the source code in the (sandboxed) test execution environment 645, and provide the source code to the LLM analysis engine (analyzer) 650 and SAST engine (tool) 655 for identification of potential vulnerabilities. Respective vulnerability outputs from the LLM analysis engine 650 and SAST engine 655 may then be provided to both the knowledge base 660 and RAG database 665 for further processing consistent with present principles.

Additionally, as also shown in FIG. 6, the application server 635 may provide the source code and commands to a RAG engine 671 (with access to a RAG database as set forth above), a database server 673, a monitoring service 675, and a log service 677 Additionally, the source code and commands may be provided by the server 645 to a test generation engine 679, result analysis engine 681, and confidence scoring engine 683 for execution of those entities consistent with present principles. Accordingly, outputs (test codes) from the test generation engine 679 may be provided to both the knowledge base 660 and RAG database 655. Outputs from the engine 681 and from the confidence scoring engine may also be provided to the knowledge base 660.

Bidirectional linking between the knowledge base 660 and RAG database 665 may then ensue, with the RAG database 665 consulting or incorporating remediating code 685, NIST Juliet benchmarks 687, OWASP benchmarks 689, and known vulnerability code 619 to execute its functions.

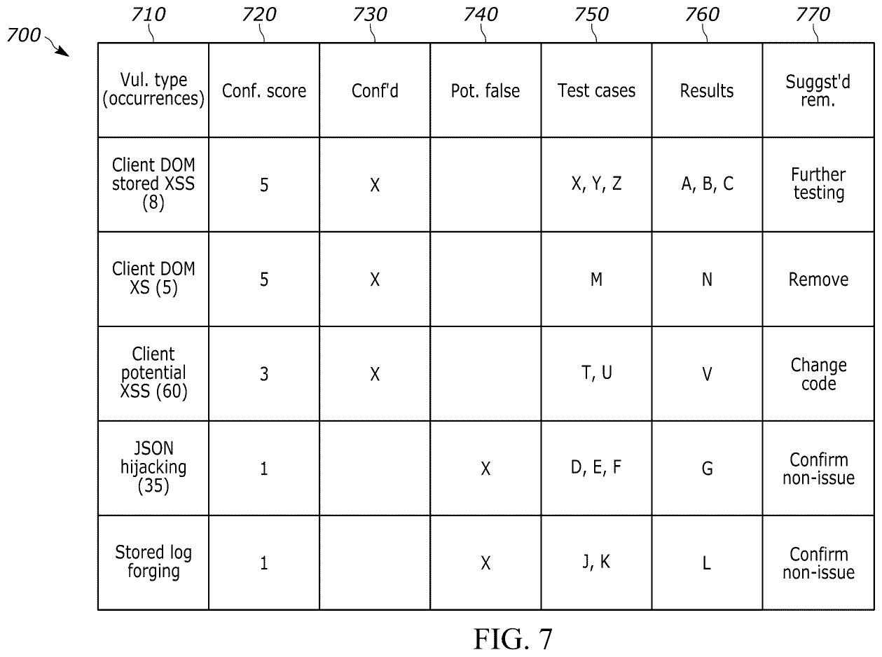

Now in reference to FIG. 7, an example vulnerability/technical report 700 is shown as might be presented on a display of a client device used by a software developer. As shown, the report 700 may include a first column 710 listing a respective vulnerability type that has been identified, as well as a number of occurrences of that vulnerability that have been detected within the software under test (in parentheses). The report 700 may also include a second column 720 ranking, in descending order, the respective vulnerabilities identified in column 710 through confidence scores. In the present example, the vulnerabilities are ranked from more critical to less critical, top to bottom, on a scale of one to five.

As also shown in FIG. 7, the report 700 may include columns 730 and 740. Column 730 may be used to mark a confirmed vulnerability as determined consistent with the disclosure above, while column 740 may instead be used to mark a potential false positive vulnerability for the respective vulnerability of that row.

The report 700 may also include a column 750 that indicates respective test cases/codes that were run on the source code itself to analyze the identified vulnerability, with column 760 then indicating the results of those test cases. Column 770 then indicates suggested remediation actions that might be undertaken in light of the respective vulnerability itself and its level of severity as expressed in its confidence score.

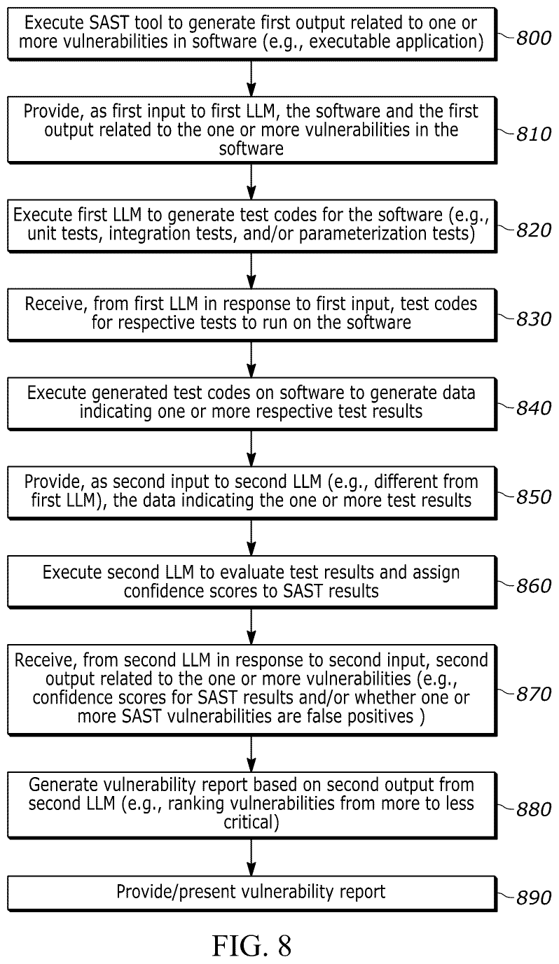

Referring now to FIG. 8, this figure shows example overall logic that may be executed by a device such as the system 100 and/or a coordinating server alone or in any appropriate combination consistent with present principles. Thus, in some examples the logic may be executed by a client device alone. In other examples, the logic may be executed by the remotely-located server alone. In still other examples, the logic may be executed by a client device and remotely-located server, where the client device performs some steps while the server performs other steps, and/or where the client device and server work together to perform a given step. Note that while the logic of FIG. 8 is shown in flow chart format, other suitable logic may also be used.

Beginning at block 800, the device may execute a static application security testing (SAST) tool to generate a first output related to one or more vulnerabilities in software (e.g., an executable application/environment). The logic may then proceed block 810 where the device may provide, as first input to a first large language model (LLM), at least the first output related to the one or more vulnerabilities in the software. Also at block 810 in some examples, the device may provide, as part of the first input to the first LLM, the source code (software) itself and/or otherwise indicate a storage location at which a copy of the source code may be accessed for ensuing logic. From block 810 the logic may then proceed to block 820.

At block 820 the device may execute the first LLM to generate test codes to test the software, including any combination of unit tests, integration tests, and/or parameterization tests as appropriate for the respective vulnerability instance. The logic may then proceed to block 830 where the device may receive, from the first LLM in response to the first input, the one or more test codes for respective tests to run on the software.

After block 830 the logic may then proceed to block 840. Here, the device may execute the generative test codes on the software to generate data indicating one or more respective test results. The logic may then proceed to block 850 where the device may provide, as second input to a second LLM (same as or different from the first LLM), the data indicating the one or more respective test results. The logic may then proceed to block 860 where the device may execute the second LLM to analyze the test results and to assign respective confidence scores to each SAST result.

Still in reference to FIG. 8, from block 860 the logic may then proceed to block 870. Here the device may receive, from the second LLM in response to the second input, a second output related to the one or more vulnerabilities. The second output may therefore indicate, in non-limiting examples, the respective confidence scores for the SAST results and/or whether one or more of the SAST vulnerabilities are false positives.

From there the logic may proceed to block 880 where the device may generate a vulnerability report based on the second output from the second LLM. For instance, the vulnerability report 700 of FIG. 7 may be generated at block 880, thus ranking vulnerabilities from more to less critical in descending order. The logic may then move to block 890. Here the device may provide the vulnerability report generated based on the second output from the second LLM, such as by presenting the vulnerability report on a display of a client device being used by an app developer to test the software.

With the foregoing in mind, a non-limiting example will now be provided for how some of the aforementioned tests might be structured for the CWE23_Relative_Path_Traversal__Environment_01 class:
1. Unit Tests: These tests may focus on testing individual methods or functions within the class. Mocking or stubbing may be used to simulate file system operations and environment variables.
2. Integration Tests: These tests may test the interaction between the source code and the actual file system or environment. They may be run in a controlled environment to prevent actual security breaches.
3. Parameterized Tests: These tests may allow the system to run the same test with multiple inputs, which may be useful for testing various potential attack vectors.

Then suppose the LLM generated several cases to verify the CWE-23 vulnerability:
1. testValidInput: Tests with a valid input to ensure normal functionality.
2. testPathTraversal: Attempts a path traversal attack on a Linux-like system.
3. testWindowsPathTraversal: Attempts a path traversal attack on a Windows system.
4. testNullInput: Tests behavior with a null input.
5. testEmptyInput: Tests behavior with an empty input.
6. testGoodG2B: Tests the good( ) method which should use a hardcoded string.

The run results might therefore be:
testValidInput: Pass
The test likely passes as it uses a valid file name.
testPathTraversal: FAIL
This test probably fails, indicating a true positive for the CWE-23 vulnerability.
The code allows accessing files outside the intended directory.
testWindowsPathTraversal: FAIL
Similar to the Linux test, this likely fails, confirming the vulnerability on Windows systems.
testNullInput: Pass
The code likely handles null input safely, not causing any file access.
testEmptyInput: PASS
Empty input is probably handled without causing unintended file access.
testGoodG2B: PASS
The ‘good’ method uses a hardcoded string, likely preventing path traversal.

Based on this, example analysis of results might include:
True Positive Confirmation: The failure of testPathTraversal and testWindowsPathTraversal confirms the presence of the CWE-23 vulnerability.
Handling of Edge Cases: The code appears to handle null and empty inputs safely.
Mitigation Effectiveness: The ‘good’ method demonstrates an effective mitigation strategy.

This might then lead to the following auto-generative confidence assessment, which might be presented as part of a report such as the report 700:
Based on these simulated results, we have high confidence that the SAST tool's identification of the CWE-23 vulnerability is accurate. The code is vulnerable to path traversal attacks on both Linux and Windows systems when using the ‘bad’method.

Also according to the foregoing non-limiting example, generative test code that might have been output by an LLM as tailored to target the relevant vulnerability may then be used to come to the relevant confidence assessment(s). This generated test code might include:
import org.junit.Before;
import org.junit.Test;
import org.junit.runner.RunWith;
import org.junit.runners.Parameterized;
import org.mockito.MockedStatic;
import org.mockito.Mockito;
import java.io.File;
import java.util.Arrays;
import java.util.Collection;
import static org.junit.Assert.*; h
import static org.mockito.Mockito.*;
@RunWith(Parameterized.class)
public class CWE23_Relative_Path_Traversal_Test {
   private CWE23_Relative_Path_Traversal__Environment_01 testObject;
   private String input;
   private boolean expectedVulnerable;
   public CWE23_Relative_Path_Traversal_Test(String input, boolean expectedVulnerable) {
      this.input=input;
      this.expectedVulnerable=expectedVulnerable;
   }
   @Parameterized.Parameters
   public static Collection<Object[]>data( ) {
      return Arrays.asList(new Object[][] {
         {“validfile.txt”, false},
         {“. . . / . . . / . . . /etc/passwd”, true},
         {“. . . \\ . . . \\ . . . \\Windows\\System32\\drivers\\etc\\hosts”, true},
         {“”, false},
      {“normal/path/file.txt”, false}
   });
}
@Before
public void setUp( ) {
   testObject=new CWE23_Relative_Path_Traversal__Environment_01( );
}
@Test
public void testBadMethod( ) throws Throwable {
   try (MockedStatic<System>mockedSystem=Mockito.mockStatic(System.class)) {
   mockedSystem.when(( )->System.getenv(“ADD”)).thenReturn(input);
   mockedSystem.when(( )->System.getProperty(“os.name”)).thenReturn(“Linux”);
   File mockFile=mock(File.class);
   when(mockFile.exists( )).thenReturn(true);
   when(mockFile.isFile( )).thenReturn(true);
   try (MockedStatic<File>mockedFile=Mockito.mockStatic(File.class)) {
      mockedFile.when(( )->new File(anyString( ))).thenReturn(mockFile);
      testObject.bad( );
      if (expectedVulnerable) {
         verify(mockFile).exists( );
         verify(mockFile).isFile( );
      } else {
         verify(mockFile, never( )).exists( );
         verify(mockFile, never( )).isFile( );
         }
      }
   }
}
@Test
public void testGoodG2BMethod( ) throws Throwable {
   try (MockedStatic<System>mockedSystem=Mockito.mockStatic(System. class)) {
      mockedSystem.when(( )->System.getProperty(“os.name”)).thenReturn(“Linux”);
      File mockFile=mock(File.class);
      when(mockFile.exists( )).thenReturn(true);
      when(mockFile.isFile( )).thenReturn(true);
      try (MockedStatic<File>mockedFile=Mockito.mockStatic(File.class)) {
         mockedFile.when(( )->new File(anyString( ))).thenReturn(mockFile);
         testObject.good( );
         verify(mockFile).exists( );
         verify(mockFile).isFile( );
      }
   }
}
}

What's more, an example code base (input to SAST and LLM) for NIST Juliet 1.3 Java test cases might be:
import java.io.*;
import javax.servlet.http.*;
import java.util.logging.Level;
public class CWE23_Relative_Path_Traversal__Environment_01 extends AbstractTestCase
{
   /*uses badsource and badsink*/
   public void bad( ) throws Throwable
   {
      String data;
      /*get environment variable ADD*/
      /*POTENTIAL FLAW: Read data from an environment variable*/
      data=System.getenv(“ADD”);
      String root;
      if(System.getProperty(“os.name”).toLowerCase( ).indexOf(“win”)>=0)
      {
         /*running on Windows*/
         root=“C: \\uploads\\”;}
      else
      {
   /*running on non-Windows*/
   root=“/home/user/uploads/”;
}
if (data!=null)
{
   /*POTENTIAL FLAW: no validation of concatenated value*/
   File file=new File(root+data);
   FileInputStream streamFileInputSink=null;
   InputStreamReader readerInputStreamSink=null;
   BufferedReader readerBufferdSink=null;
   if (file.exists( ) && file.isFile( ))
   {
      try
      {
         streamFileInputSink=new FileInputStream(file);
         readerInputStreamSink=new InputStreamReader(streamFileInputSink, “UTF-8”);
         readerBufferdSink=new BufferedReader(readerInputStreamSink);
         IO.writeLine(readerBufferdSink.readLine( ));
      }
      Catch (IOException exceptIO)
      {
         IO.logger.log(Level.WARNING, “Error with stream reading”, exceptIO);
      }
      finally
      {
         /*Close stream reading objects*/
         try
      {
         if (readerBufferdSink!=null)
         {
            readerBufferdSink.close( );
         }
      }
      catch (IOException exceptIO)
      {
         IO.logger.log(Level.WARNING, “Error closing BufferedReader”, exceptIO);
      }
      try
      {
         if (readerInputStreamSink!=null)
         {
            readerInputStreamSink.close( );
         }
      }
      catch (IOException exceptIO)
      {
         IO.logger.log(Level. WARNING, “Error closing InputStreamReader”, exceptIO);
      }
      try
      {
         if (streamFileInputSink!=null)
         {
            streamFileInputSink.close( );
            }
         }
         catch (IOException exceptIO)
         {

IO.logger.log(Level.WARNING, “Error closing FileInputStream”, exceptIO);
}
}
}
}
}
public void good( ) throws Throwable
{
   goodG2B( );
}
/*goodG2B( )-uses goodsource and badsink*/
private void goodG2B( ) throws Throwable
{
   String data;
   /*FIX: Use a hardcoded string*/
   data=“foo”;
   String root;
   if(System.getProperty(“os.name”).toLowerCase( ).indexOf(“win”)>=0)
   {
   /*running on Windows*/
   root=“C:\\uploads\\”;
}
else
{
   /*running on non-Windows*/
   root=“/home/user/uploads/”;
}
if (data!=null)
{
   /*POTENTIAL FLAW: no validation of concatenated value*/
   File file=new File(root+data);
   FileInputStream streamFileInputSink=null;
   InputStreamReader readerInputStreamSink=null;
   BufferedReader readerBufferdSink=null;
   if (file.exists( ) && file.isFile( ))
   {
      try
      {
         streamFileInputSink=new FileInputStream(file);
         readerInputStreamSink=new InputStreamReader(streamFileInputSink, “UTF-8”);
         readerBufferdSink=new BufferedReader(readerInputStreamSink);
         IO.writeLine(readerBufferdSink.readLine( ));
      }
      catch (IOException exceptIO)
      {
         IO.logger.log(Level. WARNING, “Error with stream reading”, exceptIO);
   }
   finally
   {
      /*Close stream reading objects*/
      try
      {
         if (readerBufferdSink!=null)
         {
            readerBufferdSink.close( );
         }
      }
      catch (IOException exceptIO)
      {
         IO.logger.log(Level.WARNING, “Error closing BufferedReader”, exceptIO);
      }
      try
      {
         if (readerInputStreamSink!=null)
         {
            readerInputStreamSink.close( );
         }
      }
      catch (IOException exceptIO)
      {
         IO.logger.log(Level.WARNING, “Error closing InputStreamReader”, exceptIO);
   }
      try
      {
         if (streamFileInputSink!=null)
         {
            streamFileInputSink.close( );
         }
      }
      catch (IOException exceptIO)
      {

IO.logger.log(Level.WARNING, “Error closing FileInputStream”, exceptIO);
}
}
}
}
}
/* Below is the main( ). It is only used when building this testcase on
*its own for testing or for building a binary to use in testing binary
*analysis tools. It is not used when compiling all the testcases as one
*application, which is how source code analysis tools are tested.
*/
public static void main(String[] args) throws ClassNotFoundException,
   InstantiationException, IllegalAccessException
{
   mainFromParent(args);
}
}”

It may now be appreciated that present principles provide for an improved computer-based user interface that increases the functionality and ease of use of the devices disclosed herein. The disclosed concepts are rooted in computer technology for computers to carry out their functions.

Components included in one embodiment can be used in other embodiments in any appropriate combination. For example, any of the various components described herein and/or depicted in the Figures may be combined, interchanged or excluded from other embodiments.

It is to be understood that whilst present principles have been described with reference to some example embodiments, these are not intended to be limiting, and that various alternative arrangements may be used to implement the subject matter claimed herein. Accordingly, while particular techniques and devices are herein shown and described in detail, it is to be understood that the subject matter which is encompassed by the present application is limited only by the claims.

What is claimed is:

1. A device, comprising:
a processor system; and
storage accessible to the processor system and comprising instructions executable by the processor system to:
execute a static application security testing (SAST) tool to generate a first output related to one or more vulnerabilities in a software that is to be tested;
provide, as a first input to a first large language model (LLM), the first output related to the one or more vulnerabilities in the software;
receive, from the first LLM in response to the first input, one or more test codes for respective tests to run on the software;
execute the one or more test codes on the software to generate data indicating one or more respective test results;
provide, as a second input to a second LLM, the data indicating the one or more respective test results;
receive, from the second LLM in response to the second input, a second output related to the one or more vulnerabilities; and
generate a vulnerability report based on the second output from the second LLM.

2. The device of claim 1, wherein the one or more test codes comprise one or more unit tests.

3. The device of claim 1, wherein the one or more test codes comprise one or more integration tests.

4. The device of claim 1, wherein the one or more test codes comprise one or more parameterized tests.

5. The device of claim 1, wherein the second output indicates a level of confidence in one or more SAST results from the execution of the SAST tool, the one or more SAST results related to the one or more vulnerabilities.

6. The device of claim 1, wherein the second output indicates whether a respective vulnerability of the one or more vulnerabilities is a false positive.

7. The device of claim 1, wherein the second LLM is the first LLM.

8. The device of claim 1, wherein the software establishes an executable environment.

9. The device of claim 1, wherein the instructions are executable to:
provide, as the first input to a first large language model (LLM), both the software and the first output related to the one or more vulnerabilities in the software.

10. The device of claim 1, wherein the vulnerability report is generated to rank the one or more vulnerabilities according to the second output from the second LLM.

11. The device of claim 10, wherein the one or more vulnerabilities are ranked in the vulnerability report from more critical to less critical.

12. A method, comprising:
executing a static application security testing (SAST) tool to generate a first output related to one or more vulnerabilities in a software that is to be tested;
providing, as a first input to a first large language model (LLM), the first output related to the one or more vulnerabilities in the software;
receiving, from the first LLM in response to the first input, one or more test codes for respective tests to run on the software;
executing the one or more test codes on the software to generate data indicating one or more respective test results;
providing, as a second input to a second LLM, the data indicating the one or more respective test results;
receiving, from the second LLM in response to the second input, a second output related to the one or more vulnerabilities; and
providing a vulnerability report based on the second output from the second LLM.

13. The method of claim 12, wherein the one or more test codes comprise one or more unit tests.

14. The method of claim 12, wherein the one or more test codes comprise one or more integration tests.

15. The method of claim 12, wherein the one or more test codes comprise one or more parameterized tests.

16. The method of claim 12, wherein the second LLM is different from the first LLM.

17. The method of claim 12, wherein the software establishes an executable environment.

18. At least one computer readable storage medium (CRSM) that is not a transitory signal, the at least one CRSM comprising instructions executable by a processor system to:
use one or more large language model (LLMs) to evaluate static application security testing (SAST) results from a SAST tool; and
generate a software vulnerability report based on one or more outputs from the one or more LLMs that are related to the SAST results.

19. The at least one CRSM of claim 18, wherein the instructions are executable to:
use a first LLM of the one or more LLMs to generate one or more test codes for respective tests to run on software to which the SAST results are related; and
use a second LLM of the one or more LLMs both to evaluate test results from execution of the test codes on the software and to assign, based on the evaluation of the test results, a respective confidence score in each SAST result for indication in the software vulnerability report.

20. The at least one CRSM of claim 19, wherein the one or more test codes comprise one or more unit tests, one or more integration tests, and/or one or more parameterized tests.
